(19) United States
(12) Patent Application Publication
(10) Pub. No.: US 2018/0109775 A1
(43) Pub. Date: Apr. 19, 2018

(54) METHOD AND APPARATUS FOR FABRICATING A STEREOSCOPIC IMAGE

(71) Applicant: BOE TECHNOLOGY GROUP CO., LTD., Beijing (CN)

(72) Inventors: Naifu WU, Beijing (CN); Kun WU, Beijing (CN)

(21) Appl. No.: 15/554,846

(22) PCT Filed: Feb. 20, 2017
(86) PCT No.: PCT/CN2017/074107

§ 371 Date: Aug. 31, 2017

(30) Foreign Application Priority Data
May 27, 2016 (CN) 201610365209.7

(51) Int. Cl. H04N 13/00

(52) U.S. Cl. CPC H04N 13/0029; H04N 13/0402; H04N 13/0037

(57) ABSTRACT

Embodiments of the present disclosure provide a method and apparatus for fabricating a stereoscopic image and video, the method including extracting information on each sub-pixel for each angle of view from a 2D image to compose a matrix, interweaving the matrix for each angle of view according to a cyclic unit of image arrangement, to form an interweaved image, and outputting a stereoscopic image using the interweaved image, whereby stereoscopic images may be obtained by image interweaving in combination with image arrangement.

### CROSS REFERENCE TO RELATED APPLICATIONS

This patent application is a National Stage Entry of PCT/CN2017/074107 filed on Feb. 20, 2017, which claims the benefit and priority of Chinese Patent Application No. 201610365209.7 filed on May 27, 2016, the disclosures of which are incorporated herein by reference in their entirety as part of the present application.

### BACKGROUND

The present disclosure relates generally to the field of image processing, and in particular to a method and apparatus for fabricating a stereoscopic image.

Naked-eye stereoscopic display has entered the homes of ordinary people and has had a place in the field of commercial advertising machines. In current applications of the naked-eye stereoscopic display, one problem that frequently occurs and needs to be solved is the Moire phenomenon caused by interaction between the pixel structure of the panel and the 3D display device, which affects the display effect.

### BRIEF DESCRIPTION

An object of the present disclosure is to solve the aforementioned problem by providing a method for fabricating a stereoscopic image by image interweaving in combination with image arrangement.

A method for fabricating a stereoscopic image, including extracting information on each sub-pixel for each angle of view from a 2D image to compose a matrix, interweaving the matrix for each angle of view according to a cyclic unit of image arrangement, to form an interweaved image, and outputting a stereoscopic image using the interweaved image.

The present disclosure further provides an apparatus for fabricating a stereoscopic image, including an information extracting unit for extracting information on each sub-pixel for each angle of view from a 2D image to compose a matrix, an image processing unit for interweaving the matrix for each angle of view according to a cyclic unit of image arrangement, to form an interweaved image, and an output unit for outputting a stereoscopic image using the interweaved image.

The method and apparatus for fabricating a stereoscopic image according to the present disclosure make it possible to fabricate stereoscopic images by image interweaving in combination with image arrangement, thus delivering a better naked-eye viewing effect and improving user experience.

### BRIEF DESCRIPTION OF THE DRAWINGS

The present disclosure-can be better understood by reading the following detailed description of embodiments with reference to the drawings in which:

FIG. 1 is a flow chart illustrating an embodiment of a method for fabricating a stereoscopic image according to the present disclosure;

FIG. 2 is a schematic diagram illustrating an example of forming a matrix from an image;

FIG. 3 is a flow chart illustrating a preferred embodiment of a method for fabricating a stereoscopic image according to the present disclosure;

FIG. 4 is a schematic diagram illustrating an example of gray scale processing;

FIG. 5 is a schematic diagram illustrating a matrix of sub-pixels after gray scale processing;

FIG. 6 is a flow chart illustrating a preferred embodiment of a method for fabricating a stereoscopic video according to the present disclosure;

FIG. 7 is a flow chart illustrating a process of a preferred embodiment of a method for fabricating a stereoscopic video according to the present disclosure; and

FIG. 8 is a schematic block diagram illustrating an embodiment of an apparatus for fabricating a stereoscopic image according to the present disclosure.

### DETAILED DESCRIPTION

Now embodiments of the present disclosure will be described in detail with reference to the drawings. References throughout this specification to features, advantages, or similar language do not imply that all of the features and advantages that may be realized with the present disclosure should be or are in any single embodiment of the disclosure. Rather, language referring to the features and advantages is to be understood to mean that a specific feature, advantage, or characteristic described in connection with an embodiment is included in at least one embodiment of the present disclosure. Furthermore, the described features, advantages, and characteristics of the disclosure may be combined in any suitable manner in one or more embodiments. One skilled in the relevant art will recognize that the disclosure may be practiced without one or more of the specific features or advantages of a particular embodiment. In other instances, additional features and advantages may be recognized in certain embodiments that may not be present in all embodiments of the disclosure.

In the related field, the grating is often tilted according to the pixel arrangement in order to alleviate the Moire phenomenon. This results in numerous image arrangements. In addition, gray scale difference calculation is also adopted according to different image arrangements in order to obtain better effects.

Since there are numerous image arrangements for various purposes, it is difficult to know how to obtain a stereoscopic image based on a combination of image arrangement and image interweaving.

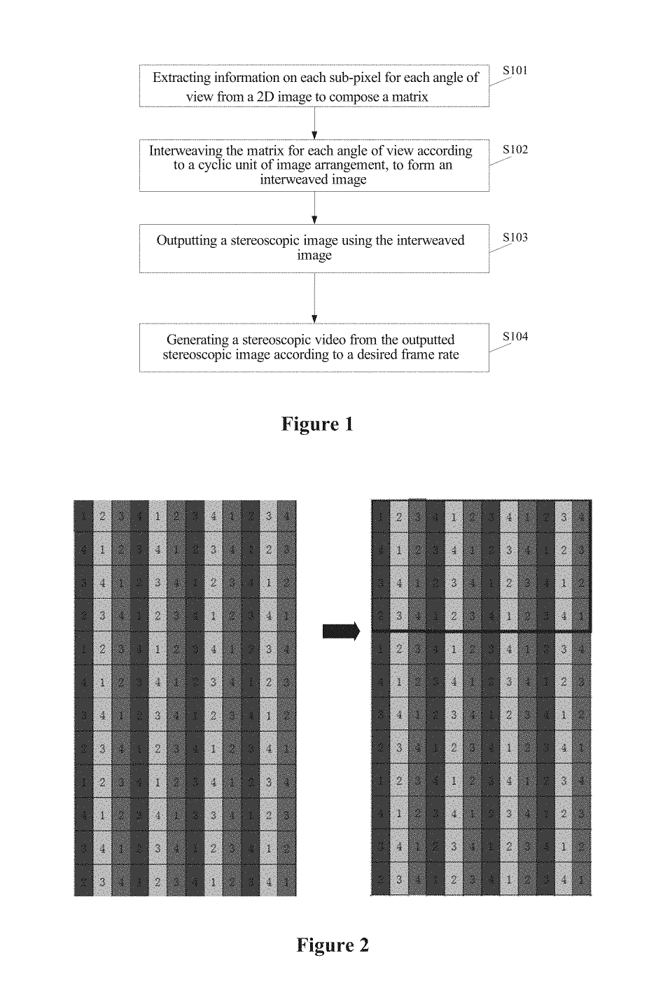

As shown in FIG. 1, a method for fabricating a stereoscopic image according to the present disclosure includes step S101 of extracting information on each sub-pixel for each angle of view from a 2D image to compose a matrix, step S102 of interweaving the matrix for each angle of view according to a cyclic unit of image arrangement, to form an interweaved image, and step S103 of outputting a stereoscopic image using the interweaved image. The interweaving includes, for example, composing an image or video having 3D information using two images, i.e., a left-view image and a right-view image according to a pixel arrangement rule.

The method for fabricating a stereoscopic image according to the present disclosure make it possible to fabricate a stereoscopic image by image interweaving in combination with image arrangement, delivering a better naked-eye viewing effect, and thus improving the user experience.

According to one embodiment, in order to reduce interference, the method for fabricating a stereoscopic image further includes after step S102, if it is desired to perform gray scale processing, determining whether to perform gray scale processing on a sub-pixel in the interweaved image according to the position of the sub-pixel in the matrix, and taking a corresponding action according to the determination result. Therefore, a logical operation may be used to perform gray scale difference processing, in order to reduce image interference.

According to one embodiment, the method for fabricating a stereoscopic image further includes prior to step S101, compressing the 2D image to a specific resolution in proportion.

According to one embodiment, the gray scale processing includes gray-scale summing and averaging for sub-pixels in a matrix boundary.

According to one embodiment, the gray scale processing includes reducing the gray scale of the sub-pixels in the matrix boundary by, for example, two thirds.

According to one embodiment, the method for fabricating a stereoscopic image further includes step S104 of generating a stereoscopic video from the outputted stereoscopic image according to a desired frame rate.

The method for fabricating a stereoscopic image according to the present disclosure will be described by a specific example as follows.

To fabricating a naked-eye stereoscopic image or video, the following conditions must be met.

First, the display screen (such as LCD or OLED) must be in the point-to-point output mode. In this way, it is prevented that the field-of-view design cannot be realized due to the image rendering.

Second, the naked-eye image arrangement must be known. Taking a ⅓ image arrangement of 4 images as an example, as shown in FIG. 2, it is necessary to indicate the information (gray scale and color) corresponding to an angle of view (denoted by numerals 1, 2, 3, and 4 in the figure) for each sub-pixel.

Finally, a cyclic (repeating) unit is found and then used for encoding.

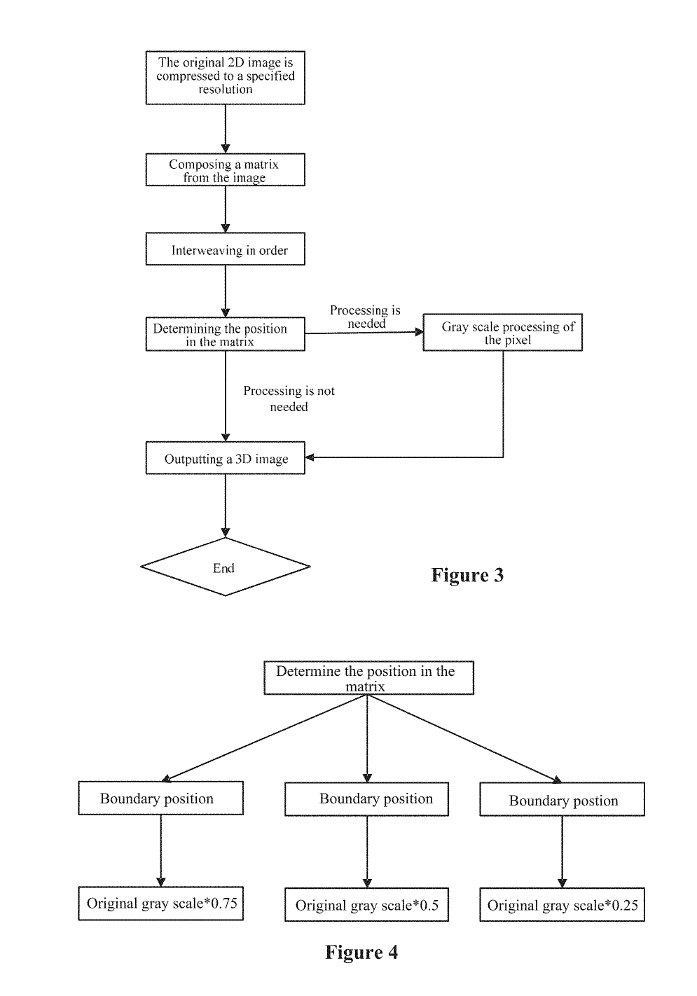

An exemplary process for fabricating a stereoscopic image will now be described, as shown in FIG. 3.

First, an original 2D image, such as a side-by-side image that needs to be arranged is compressed to a specific resolution in proportion (this step may be omitted if the original 2D image meets the requirement on resolution).

Second, information on each sub-pixel for each angle of view is extracted from the 2D image to compose a matrix.

The side-by-side image is divided into a left image and a right image which are used to generate a depth image. N images with parallax are generated from the depth image and are formed into a matrix. For example, if N is equal to four, these four images are numbered as images 1-4 and the pixel cycle in the four images are numbered as 1-4.

The matrixes of the angle of views are interwoven according to the cyclic unit of the image arrangement to form a new image. The interweaving process may include extracting the pixels numbered as 1 in image 1 and combining it with the pixels numbered as 2 in image 2, the pixels numbered as 3 in image 3, and the pixels numbered as 4 in image 4 to form a new image.

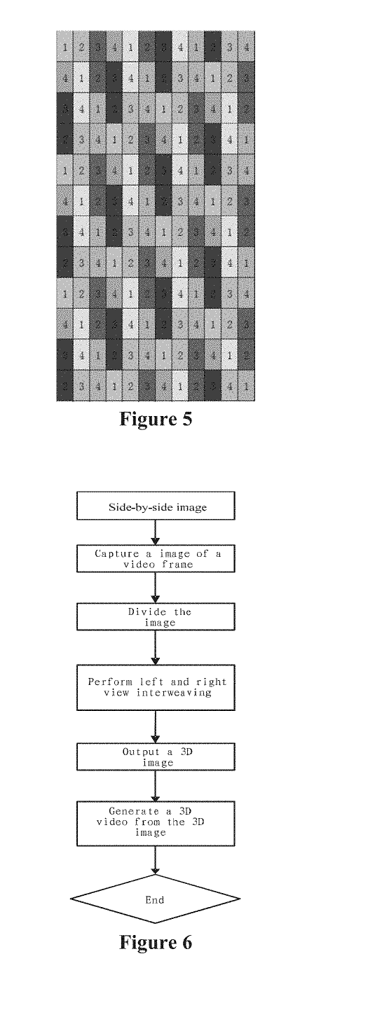

Thereafter, as shown in FIG. 4, the positions of the pixels at the boundary of the matrix, such as pixels 1 and 4, are determined. If gray scale processing needs to be performed, it is necessary to sum and average the gray scales of pixels 1 and 4, and assigned the value to the pixels 1 and 4 respectively. If there is a special need, such as, to reduce the gray scale to one third of the original, it can also be processed in this step. The processed image is shown in FIG. 5.

Finally, the fabricated naked-eye stereoscopic image is outputted.

Described above is the process of fabricating a naked-eye stereoscopic image from multiple images. If desired, a stereoscopic video may also be fabricated using multiple consecutive naked-eye stereoscopic images according to a particular frame rate.

On the basis of the method for fabricating a stereoscopic image provided by the present disclosure, a stereoscopic video can be obtained, which will be described in details hereunder.

According to one embodiment, the method for fabricating a stereoscopic image further includes prior to step S101, extracting a 2D image of a video frame from a 2D video file, and after step S102, performing left and right view interweaving on the image that has gone through gray scale processing.

After step S103, generating a stereoscopic video using the outputted stereoscopic images.

The stereoscopic video is thus produced in a manner from a video to images and then to a video. In addition, a gray scale processing rule and calculation are adopted in order to reduce interference, whereby the naked-eye stereoscopic effects are optimized.

The process of fabricating a stereoscopic video will be described by an example as follows.

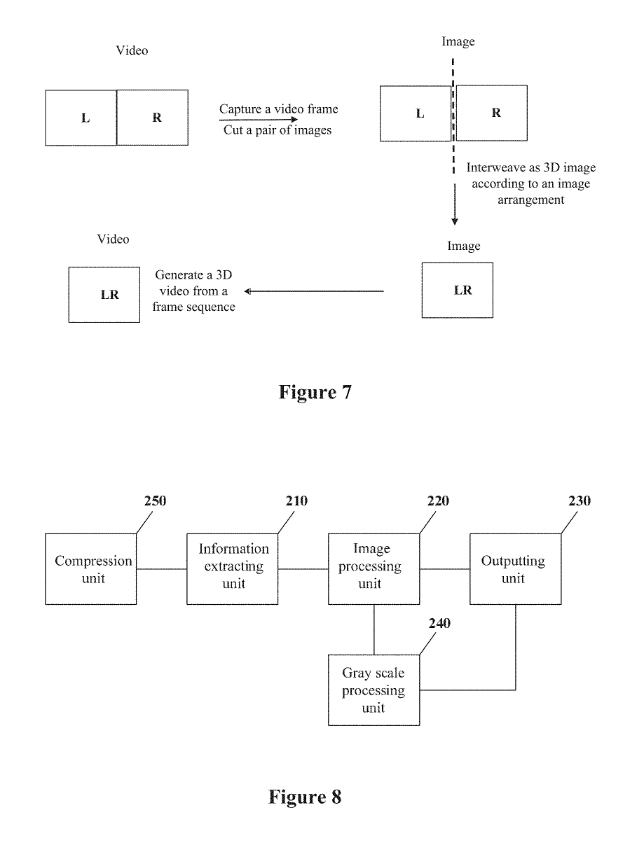

As shown in FIGS. 6 and 7, a frame image is extracted from a side-by-side video file, then the image is divided, finally, image interweaving is carried out as described above. In dividing the image, the image may be divided into a left image and a right image and a matrix may be obtained as described above. A gray scale processing may be performed after the image interweaving as described above. Thus a naked-eye stereoscopic video is obtained from the side-by-side video. As shown in FIG. 7, L and R represent a left view and a right view, respectively, the resolution of which may be, for example, 4 k×2 k, and the 3D image and video generated may have the same resolution.

The present disclosure further provides an apparatus for fabricating a stereoscopic image, as shown in FIG. 8, including an information extracting unit 210 configured to extract information on each sub-pixel for each angle of view from a 2D image to compose a matrix, an image processing unit 220 configured to interweave the matrix for each angle of view according to a cyclic unit of image arrangement, to form an interweaved image, and an output unit 230 configured to output a stereoscopic image using the interweaved image.

According to one embodiment, the apparatus for fabricating a stereoscopic image further includes a gray scale processing unit 240 configured to, after the image processing unit 220 interweaving the matrix for each angle of view according to the cyclic unit of the image arrangement, if it is desired to perform gray scale processing, determine whether to perform gray scale processing on a sub-pixel in the interweaved image according to the position of the sub-pixel in the matrix and take a corresponding action according to the determination result.

According to one embodiment, the apparatus for fabricating a stereoscopic image further includes a compressing unit 250 configured to compress the 2D image to a specific resolution in proportion prior to the information extracting unit 210 extracting information on each sub-pixel for each angle of view from the 2D image.

According to one embodiment, the gray scale processing unit 240 is configured to perform gray-scale summing and averaging for sub-pixels in a matrix boundary.

According to one embodiment, the gray scale processing unit 240 is configured to reduce the gray scale of sub-pixels in the matrix boundary by two thirds.

According to one embodiment, the output unit 230 is further configured to generate a stereoscopic video from the outputted stereoscopic image according to a desired frame rate.

According to one embodiment, the information unit 210 is further configured to extract a 2D image of a video frame from a 2D video file, the image processing unit 220 is further configured to perform left and right view interweaving on the image that has gone through gray scale processing after the gray scale processing unit determining whether to perform gray scale processing on a sub-pixel in the interweaved image according to the position of the sub-pixel in the matrix, and the output unit 230 is further configured to generate a stereoscopic video using the outputted stereoscopic image after outputting the stereoscopic image from the interweaved image.

Any of the information extracting unit 210, image processing unit 220, output unit 230, gray scale processing unit 240, and compression unit 250 may be integrated together or embodied as separate components and may be of any type suitable to the local technical environment, and may include one or more of general purpose computers, special purpose computers, microprocessors, digital signal processors (DSPs) and processors based on a multi-core processor architecture, as non-limiting examples. ROMs may be of any type suitable to the local technical environment and may be implemented using any suitable data storage technology, such as semiconductor based memory devices, flash memory, magnetic memory devices and systems, optical memory devices and systems, fixed memory, and removable memory.

In general, the various exemplary embodiments may be implemented in hardware or special purpose circuits, software, logic, or any combination thereof. For example, some aspects may be implemented in hardware, while other aspects may be implemented in firmware or software which may be executed by a controller, microprocessor, or other computing device, although the disclosure is not limited thereto. While various aspects of the exemplary embodiments of this disclosure may be illustrated and described as block diagrams, flow charts, or using some other pictorial representation, it is well understood that these blocks, apparatus, systems, techniques, or methods described herein may be implemented in, as non-limiting examples, hardware, software, firmware, special purpose circuits or logic, general purpose hardware or controller or other computing devices, or some combination thereof.

At least some aspects of the disclosure may be embodied in computer-executable instructions, such as in one or more program modules, executed by one or more computers or other devices. Generally, program modules include routines, programs, objects, components, data structures, and so forth, which perform particular tasks or implement particular abstract data types. The computer executable instructions may be stored on a computer readable medium such as a hard disk, optical disk, removable storage media, solid state memory, RAM, etc. As will be appreciated by one of skill in the art, the functionality of the program modules may be combined or distributed as desired in various embodiments. In addition, the functionality may be embodied in whole or in part in firmware or hardware equivalents such as integrated circuits, field programmable gate arrays (FPGA), and the like.

Although the disclosure has been described by way of examples of embodiments, it is to be understood that various other modifications may be made within the spirit and scope of the disclosure. Therefore, the scope of the disclosure is not limited to these embodiments, and it is the object of the appended claims to cover any and all such variations and modifications as come within the true spirit and scope of the disclosure.

1. A method for fabricating a stereoscopic image comprising:
extracting information on each sub-pixel for each angle of view from a 2D image to compose a matrix;
interweaving the matrix for each angle of view according to a cyclic unit of image arrangement to form an interweaved image; and
outputting a stereoscopic image using the interweaved image.

2. The method according to claim 1, further comprising:
after the step of interweaving the matrix for each angle of view according to a cyclic unit of image arrangement, if it is desired to perform gray scale processing, determining whether to perform gray scale processing on a sub-pixel in the interweaved image according to a position of the sub-pixel in the matrix and taking a corresponding action according to the determination result.

3. The method according to claim 1, further comprising:
prior to the step of extracting information on each sub-pixel for each angle of view from the 2D image, compressing the 2D image to a specific resolution in proportion.

4. The method according to claim 2, wherein the gray scale processing comprises gray-scale summing and averaging for sub-pixels in a matrix boundary.

5. The method according to claim 4, wherein the gray scale processing comprises:
reducing a gray scale of the sub-pixels in the matrix boundary by two thirds.

6. The method according to any of claims 1, further comprising:
generating a stereoscopic video from the outputted stereoscopic image according to a desired frame rate.

7. The method according to claim 2, further comprising:
prior to the step of extracting information on each sub-pixel for each angle of view from the 2D image, extracting a 2D image of a video frame from a 2D video file;
after the step of determining whether to perform gray scale processing on a sub-pixel in the interweaved image according to the position of the sub-pixel in the matrix, performing left and right view interweaving on the image that has gone through the gray scale processing; and
after the step of outputting the stereoscopic image using the interweaved image, generating a stereoscopic video using the outputted stereoscopic image.

8. An apparatus for fabricating a stereoscopic image comprising:
an information extracting unit configured to extract information on each sub-pixel for each angle of view from a 2D image to compose a matrix;
an image processing unit configured to interweave the matrix for each angle of view according to a cyclic unit of image arrangement to form an interweaved image; and
an output unit configured to output a stereoscopic image using the interweaved image.

9. The apparatus for fabricating a stereoscopic image according to claim 8, further comprising:
a gray scale processing unit configured to, after the image processing unit interweaving the matrix for each angle of view according to the cyclic unit of the image arrangement, if it is desired to perform gray scale processing, determine whether to perform gray scale processing on a sub-pixel in the interweaved image according to a position of the sub-pixel in the matrix and take a corresponding action according to the determination result.

10. The apparatus for fabricating a stereoscopic image according to claim 8, further comprising:
a compressing unit configured to compress the 2D image to a specific resolution in proportion prior to the information extracting unit extracting information on each sub-pixel for each angle of view from the 2D image.

11. The apparatus for fabricating a stereoscopic image according to claim 9, wherein the gray scale processing unit is configured to perform gray-scale summing and averaging on sub-pixels in a matrix boundary.

12. The apparatus for fabricating a stereoscopic image according to claim 11, wherein the gray scale processing unit is configured to reduce a gray scale of the sub-pixels in the matrix boundary by two thirds.

13. The apparatus for fabricating a stereoscopic image according to claim 8, wherein the output unit is further configured to generate a stereoscopic video using the outputted stereoscopic image according to a desired frame rate.

14. The apparatus for fabricating a stereoscopic image according to claim 9, wherein:
the information unit is further configured to extract a 2D image of a video frame from a 2D video;
the image processing unit is further configured to perform left and right view interweaving on the image that has gone through gray scale processing after the gray scale processing unit determining whether to perform gray scale processing on a sub-pixel in the interweaved image according to the position of the sub-pixel in the matrix; and
the output unit is further configured to generate a stereoscopic video using the outputted stereoscopic image after the outputting unit outputting the stereoscopic image from the interweaved image.

15. The method according to claim 2, further comprising:
prior to the step of extracting information on each sub-pixel for each angle of view from the 2D image, compressing the 2D image to a specific resolution in proportion.

16. The apparatus for fabricating a stereoscopic image according to claim 9, further comprising:
a compressing unit configured to compress the 2D image to a specific resolution in proportion prior to the information extracting unit extracting information on each sub-pixel for each angle of view from the 2D image.

17. The apparatus for fabricating a stereoscopic image according to claim 9, wherein the output unit is further configured to generate a stereoscopic video using the outputted stereoscopic image according to a desired frame rate.

18. The apparatus for fabricating a stereoscopic image according to claim 10, wherein the output unit is further configured to generate a stereoscopic video using the outputted stereoscopic image according to a desired frame rate.

19. The apparatus for fabricating a stereoscopic image according to claim 11, wherein the output unit is further configured to generate a stereoscopic video using the outputted stereoscopic image according to a desired frame rate.

20. The apparatus for fabricating a stereoscopic image according to claim 12, wherein the output unit is further configured to generate a stereoscopic video using the outputted stereoscopic image according to a desired frame rate.
